(19) United States
(12) Patent Application Publication
(10) Pub. No.: US 2022/0143930 A1
(43) Pub. Date: May 12, 2022

(54) STAND-UP FLEXIBLE CONTAINERS AND METHODS AND APPARATUSES FOR PRODUCING THE CONTAINERS

(71) Applicant: Goglio S.p.A., Milano (MI) (IT)

(72) Inventors: Franco GOGLIO, Milano (MI) (IT); Daniele TENCALLA, Milano (MI) (IT)

(21) Appl. No.: 17/441,691

(22) PCT Filed: Mar. 18, 2020
(86) PCT No.: PCT/IB2020/052476

§ 371 Date: Sep. 21, 2021

(30) Foreign Application Priority Data
Mar. 25, 2019 (IT) 102019000004261

(51) Int. Cl. B29C 65/18; B29C 65/74; B29C 65/00; B65D 75/00

(52) U.S. Cl. CPC B29C 65/18; B29C 65/7451; B29C 66/1122; B29C 66/3452; B29C 66/4312; B29C 66/81419; B29L 2031/712; B29C 66/81463; B29C 66/8322; B29C 66/8432; B29C 66/851; B65D 75/008; B29C 66/81435

(57) ABSTRACT

A container may include an envelope made of flexible material, wherein the envelope includes lower and upper ends, and wherein the envelope is closed at least at the lower end. The envelope may include: opposite first walls, each having an edge at the lower end; a base at the lower end, configured to rest upon a support surface; and a pair of additional walls between the first walls, wherein each additional wall is joined to the first walls via a pair of additional edges, and wherein each additional wall has a lower folding zone at the base. Each edge may be defined by a heat seal formed between a first wall and the base. The base may be formed with a shape that defines a concavity designed to face the support surface. The base may include a pair of half-parts separated by a central fold to define the concavity.

### FIELD OF THE INVENTION

The present invention relates to a flexible container, and a method and an apparatus for producing such container, as defined in the preambles of claims 1 and 7 respectively.

The flexible container of the present invention is adapted for use in the field of product packaging, in particular non-cohesive products such as powders, liquids or gelatinous or pasty substances. This container has been specially designed for the food-processing, manufacturing and pharmaceutical industries. For example, it is adapted to contain products such as coffee grounds or beans, fruit juices, sauces and else, or animal feed. Of course, the foregoing does not limit the application of the container of the invention, which may be used in any technical field in which products, namely non-cohesive products, must be contained.

### PRIOR ART

Flexible containers are known in the art.

In particular, such container substantially has the shape of a parallelepiped, and has a base, a top and four side walls. The base and the top are closed by heat-seals. In particular, both the container and the heat-seals are bent to impart a substantially flat shape to the base. Thus, when the container is full, the base will be able to stably support the container.

In order to ensure and prevent contamination of the product, the container is formed in a sterile environment and is later sealed and then transferred from the production site to a plant in which is reopened and filled. Typically, it is reopened at its top, which is cut downstream from the heat seal.

One drawback is that, while the prior art flexible container is stably self-standing when it is full, the same does not apply when it is empty. Hence, this drawback has to be tackled in the filling plant, e.g. by equipping that plant with a machine that can grasp the container and hold it firmly in position as the product is being filled, thereby preventing the container from tipping over.

### SUMMARY OF THE INVENTION

Therefore, the technical purpose of the present invention is to provide a container that can obviate the aforementioned prior art drawbacks. Moreover, the object of the present invention is to provide a method and an apparatus for producing such container.

In particular, the object of the present invention is to provide a container that has a self-standing ability even when it is empty.

The aforementioned technical purpose and objects are substantially fulfilled by a container that comprises the technical features as disclosed in one or more of the accompanying claims.

Namely, a container of the present invention comprises an envelope made of flexible material. This envelope has a lower end and an upper end opposite to the lower end. The envelope is closed at least at the lower end.

The envelope comprises a pair of opposite walls, each having a respective edge at the lower end of the envelope. A base is placed at the lower end and is configured to rest upon a support surface.

The edges are particularly defined each by a respective heat seal formed between the respective wall and the base, for supporting the envelope.

The present invention further relates to a method of producing the container. This method comprises the step of providing a continuous tube made of flexible material. The tube has at least one pair of opposite walls.

The method further comprises the step of forming a base of an envelope. During the step of forming the base, the tube is sealed at a first sealing zone.

During the step of forming the base a respective edge is defined on each wall, at the first sealing zone.

The portion of the tube that comprises the first sealing zone is separate, to thereby define an envelope of the container.

It shall be noted that the substep of defining the edges is carried out by heat-sealing the tube between the walls and the base, to form a heat seal at each edge.

The present invention also relates to an apparatus for producing a container using the above discussed method. In particular, the apparatus comprises feeding means for feeding the continuous tube made of flexible material.

The apparatus further comprises first heat-sealing means located at a processing zone. The first heat-sealing means are designed to face the walls of the tube to heat-seal them and define a sealing zone on the tube.

Cutting means are located at the processing zone to face the sealing zone, so that they may cut it and separate the envelope from the tube.

The apparatus further comprises second heat-sealing means located at the processing zone and designed to face the walls of the tube to heat-seal each wall at an edge thereof and to define the heat seals.

The invention solves the technical problem. Indeed, the provision of the aforementioned heat seals between the walls and the base allows the container to rest on such heat seals when it is empty, and to be able to stand firmly in its preferred orientation, i.e. with the base facing a support surface.

### LIST OF DRAWINGS

Further features and advantages of the present invention will result more clearly from the illustrative, non-limiting description of a preferred, non-exclusive embodiment of a container, a method and an apparatus for producing such container as shown in the annexed drawings, in which:

FIG. 1 is a perspective view of a container of the present invention;

FIG. 2 is a bottom perspective view of the container of FIG. 1;

FIGS. 3a, 3b and 3c are perspective views of an apparatus for producing the container of FIGS. 1 and 2 in respective operating configurations;

FIGS. 4a, 4b and 4b are side views of a detail of the apparatus of FIGS. 3a-3c in respective operating configurations; and

FIGS. 5a, 5b, 5c are schematic representations of respective steps of a method of producing the container of FIGS. 1 and 2.

### DETAILED DESCRIPTION

Referring to the annexed figures, numeral 1 designates a container of the present invention.

The container 1 particularly comprises an envelope 2.

Such envelope 2 is made of flexible material. Furthermore, the material that forms the envelope 2 is at least partially heat-sealable. Preferably, the material that forms the envelope 2 is a multilayer material comprising at least one layer of heat-sealable material. Various materials of this type are known to the skilled person, therefore the properties of the material that form the envelope 2 will not be further described.

In the preferred embodiment, the envelope 2 defines the container 1 of the invention. In further embodiments, not shown, the container 1 may comprise additional elements distinct from the envelope 2.

The envelope 2 has a lower end 2a and an upper end 2b opposite to the lower end 2a. It shall be noted that the envelope 2 is closed at least at the lower end 2a. Preferably, the envelope 2 is closed at both ends 2a, 2b. Advantageously by this arrangement the envelope 2 is sealed, and its sterility is ensured until it will be opened to receive the product to be contained therein.

It shall be noted that the envelope 2 has a base 4 at the lower end 2a. This base 4 has the purpose to rest upon a support surface (not shown) and to allow the container 1 to stand with a predetermined orientation. In particular, the base 4 has a substantially rectangular plan shape.

According to the present invention, the base 4 is formed with a shape that defines a concavity 9, which is designed to face a support surface. More in detail, the base 4 comprises a pair of half parts 4a separated by a central fold 4b, to thereby define the concavity 9. Further details about the base 4 will be provided hereinbelow.

The envelope 2 also comprises a pair of walls 3. These walls 3 are opposite to each other. The walls 3 have a substantially flat and rectangular shape. According to the present invention, each wall 3 has a respective edge 3a at the lower end 2a of the envelope 2. The edges 3a are substantially parallel to each other. Each half-part 4a of the base 4 is joined to a respective wall 3 by a respective edge 3a.

It shall be noted that the edges 3a are each defined by a respective heat seal 8. This heat seal 8 is formed between a respective wall 3 and the base 4, in particular a respective half-part 4a, for supporting the envelope 2. Further details about how the heat seal 8 is formed will be provided hereinbelow.

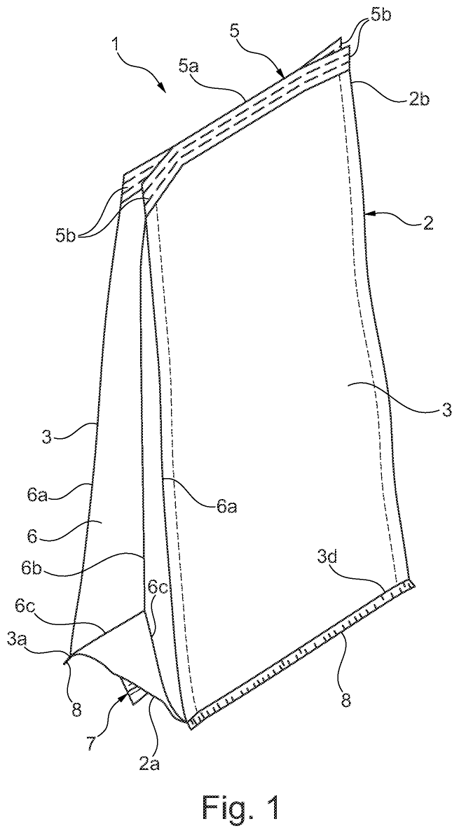

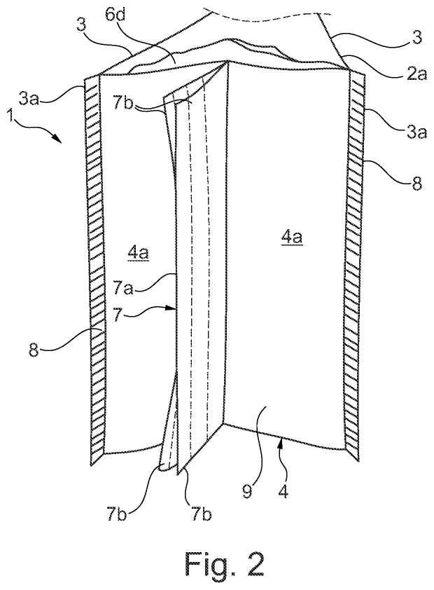

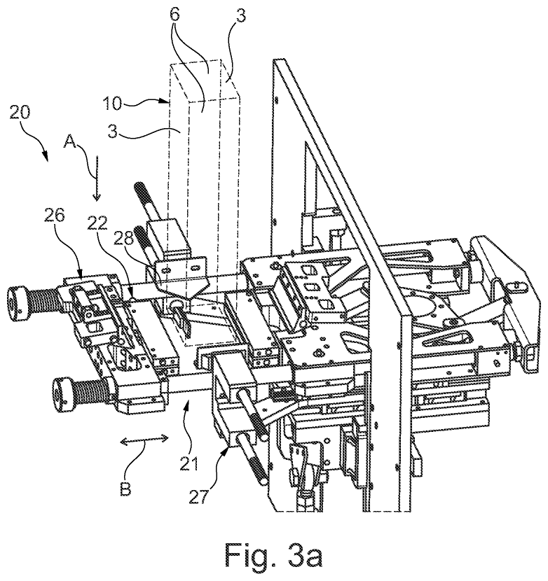

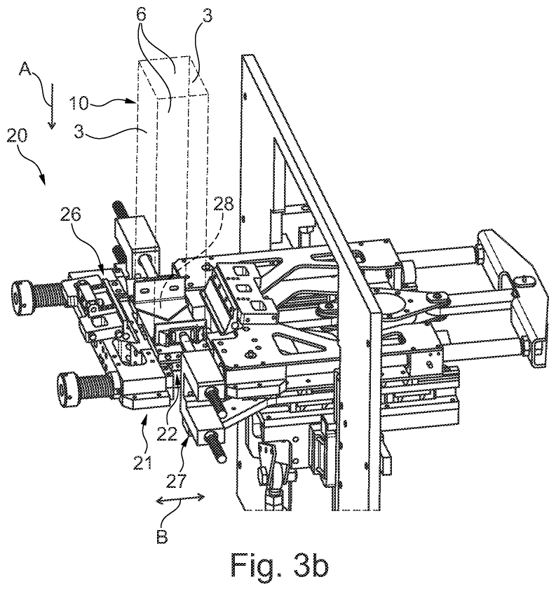

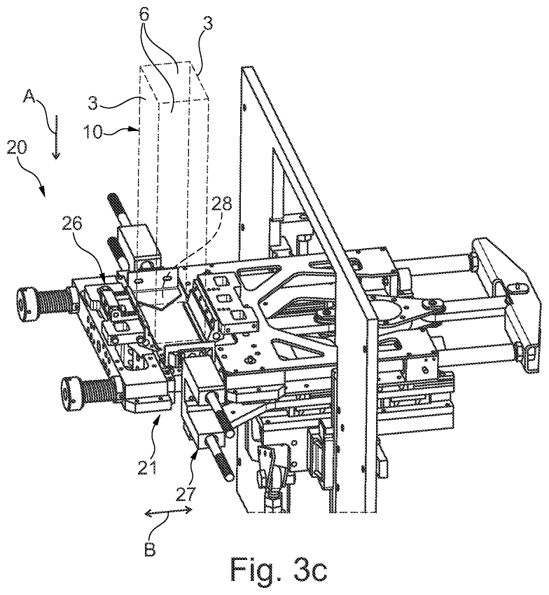

Particularly referring to FIGS. 1 and 2, it shall be noted that the heat seals 8 extend along the entire length of the edges 3a. Each heat seal 8 has a transverse extent of at least 0.5 mm, preferably of 1 mm.

The envelope 2 also comprises a pair of additional walls 6, arranged between the walls 3. Each additional wall 6 is in particular joined to the walls 3 via a pair of additional edges 6a. Preferably, the additional edges 6a are defined by heat sealing when forming the envelope 2. Each additional wall 6 also has a central fold 6b, which extends parallel to the additional edges 6a. A pair of lateral folds 6c joins the central fold to the aforementioned edges 3a of the walls 3. Further details about the additional walls 6 will be provided hereinbelow.

More in detail, the upper end 2b of the envelope 3 is closed by a first cross heat seal 5. The first cross heat seal 5 has a central area 5a, in which the walls 3 are directly joined together. Two opposite pairs of limbs 5b extend from the central area 5a. Each limb 5b is defined by the junction of an additional wall 6 with a respective wall 3. It shall be noted that the aforementioned central folds 6b of the additional walls 6, extend from the central zone 5a, and each separates two limbs 5b.

It will be appreciated that the additional walls 6 each have a respective lower folding zone 6d at the base 4. Advantageously, this allows the half-parts 4a of the base 4 to move toward each other, thereby defining the aforementioned concavity 9.

Likewise, the lower end 2a is closed by a second cross heat seal 7. The second cross heat seal 7 has a central area 7a in which the half-parts 4a of the base 4 are directly joined together. Two opposite pairs of limbs 7b extend from the central area 7a. Each limb 7b is defined by the junction of an additional wall 6 with a respective half-part 4a of the base 4. It shall be noted that the second cross heat seal 7 is formed at the central fold line 4b whereby, when the container 1 is full, it can be easily folded to collapse on the base 4.

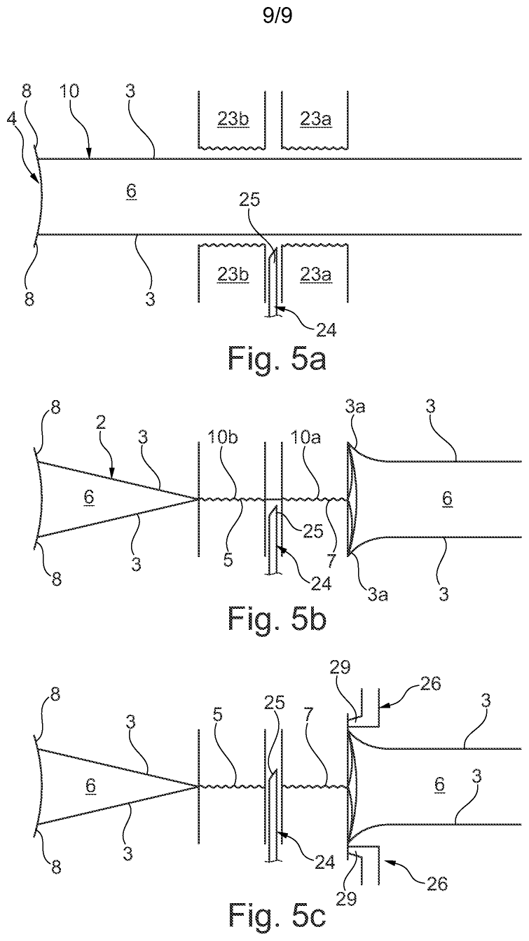

The present invention further relates to a method of producing the container 1. This method is schematically shown in FIGS. 5a, 5b and 5c, reference being made thereto hereinafter.

As shown in FIG. 5a, a continuous tube 10 is provided which is made of flexible material and is particularly at least partially heat-sealable. The tube 10 comprises the aforementioned walls 3. Furthermore, the tube 10 comprises the additional walls 6.

The method also comprises a step of forming the base 4 of the above discussed envelope 2.

As the base 4 is being formed, the additional walls 6 are folded toward the interior of the tube 10, to thereby define the aforementioned concavity 9. Furthermore, by folding the additional walls 6 the central fold 6a, the lateral folds 6c and the lower folding areas 6d are defined on each additional wall 6. Moreover, during the folding step, the walls 3 of the envelope 10 are moved toward each other.

After the folding step, the formation of the base 4 comprises a sub-step of sealing the tube 10, thereby defining a first sealing zone 10a.

It shall be noted that the tube 10 is sealed by applying two cross heat seals 5, 7 close to each other as shown in FIG. 5b. In particular, the first cross heat seal 5 closes the upper end 2b of the envelope 2 of a previously formed container 1, whereas the second cross heat seal 7 closes the lower end 2a of the envelope 2 of a container 1 that is being formed.

Once the tube 10 has been sealed, each wall 3 has a respective edge 3a defined thereon, in particular at the first sealing zone 10a. According to the present invention and as described above concerning the envelope 2, the substep of defining the edges 3a is carried out by heat-sealing the tube 10 between said walls 2 and the base 4 being defined, thereby forming the heat seals 8 at the edges 3a. It should be noted that the heat-sealing operation is carried out simultaneously on both edges 3a.

The portion of the tube 10 that comprises the base 4 is thus separated. The separation is obtained by further sealing the tube 10 at a second sealing zone 10b, which is situated at a predetermined distance from the base 4 that has been formed. Typically, this is obtained by repeating the step of forming the base 4 for a new container 1. Then. the tube 10 is cut between a first cross heat seal 5 and a second cross heat seal 7.

The present invention further relates to an apparatus 20 for producing the container 1. This apparatus 20 is able to implement the above discussed method, as better explained hereinafter.

The apparatus 20 comprises feeding means (not shown) for the tube 10. These feeding means are well-known to the skilled person and are embodied, for example, by a pair of belt conveyors which contact the additional walls 6 of the tube 10. The feeding means operate to move the tube 10 forward in a direction of feed “A” which, in the preferred embodiment, is a vertical downward direction.

The apparatus 20 has a processing zone 21, through which the tube 10 slides as the containers 1 are being formed.

First heat-sealing means 22 are located at the processing zone 21. In operation, the first heat-sealing means 11 face the walls 3 of the tube 10 to heat-seal them and define a sealing zone 10a, 10b on the tube 10.

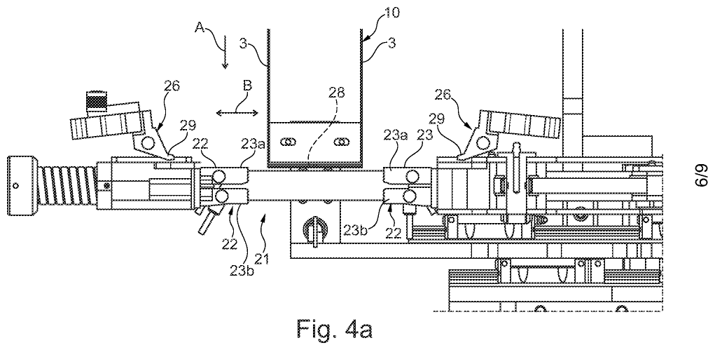

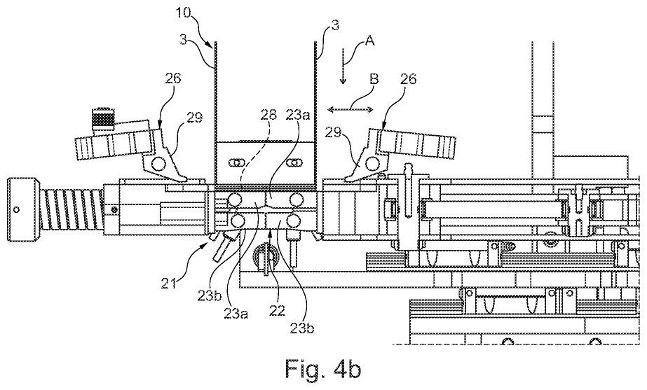

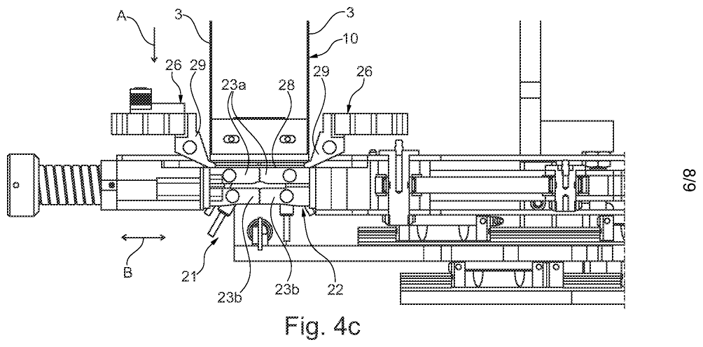

In particular, the first heat-sealing means 22 comprise a pair of mutually facing first plates 23. Each first plate 52, 23 is designed to face a respective wall 3 of the tube 10. More in detail, the first plates 23 are adapted to be alternated between an open configuration and a clamped configuration. In the open configuration, as shown for example in FIG. 4a, the first plates 23 are spaced apart from each other by a distance greater than the distance between the walls 3 of the tube 10, to allow the tube 10 to slide therein. In the clamped configuration, as shown for example in FIG. 4, the first plates 23 each contact a respective wall 3 of the tube 10, to thereby press them together, heat them and cause them to be heat-sealed. The alternation between the open configuration and the clamped configuration occurs by moving the first plates 23 in an actuation direction “B” which is transverse, in particular perpendicular to the direction of feed “A” of the tube 10.

Particularly referring to FIG. 4a, it shall be noted that each first plate 23 comprises two half-plates 23a, 23b in spaced apart relation. As particularly shown in schematic fashion in FIG. 5b, the function of the first plates 23 is to form the cross heat seals 5, 7. In particular, the upstream pair of half-plates 23a defines the second cross heat seals 7, and the downstream pair of half-plates 23b defines the first cross heat seals 5.

Cutting means 24 are located at the processing zone 21. These cutting means 24, in operation, are designed to face the sealing zone 10a, 10b to cut it and separate the envelope 2 from the tube 10. The cutting means 24 comprise a blade 25, which is placed between the two half-plates 23a, 23b. In operation, the blade 25 is adapted to cut a portion of the tube 10 to define an envelope 2. In particular, the blade 25 operates between the first cross heat seal 5 and the second cross heat seal 7 which are formed on the tube 10 during the step of forming the base 4, as shown for example in FIG. 5c.

The apparatus 20 further comprises folding means 27 located at the processing zone 21 and also designed to face the tube 10, in particular the additional walls 6. Such folding means 27 have the purpose to fold the additional walls 6 of the tube to thereby move the walls 3 toward each other. More in detail, the folding means 27 are embodied by a pair of wedges 28, each facing a respective additional wall 6 of the tube 10. In operation, the folding means 27 are actuated before the first heat-sealing means 22. In particular, the wedges 28 are moved toward each other, thereby folding the additional walls 6, whereupon the first plates 23 move from the open configuration to the clamped configuration as discussed above. Once the cross-heat seals 5, 7 gave been formed, the folding means 27 are disengaged, and the wedges 28 are moved away from the tube 10.

The apparatus further comprises second heat-sealing means 26 also located at the processing zone 21. In particular, the second heat-sealing means 26 are designed to face the walls 3 of the tube 10, to thereby heat-seal each wall 3 at a respective edge 3a and define the heat seals 8 of the container 1.

More in detail, the second heat-sealing means 26 comprise a pair of second plates 29. Each second plate 29 is associated with a respective first plate 23 and has the purpose define the aforementioned heat seal 8 at the edges 3a of the walls 3.

It should be noted that the seconds plates 29 are adapted to be alternated between an inactive configuration and an active configuration. In the inactive configuration, as shown in FIG. 4b, the second plates 29 are spaced from by the walls 3 and from their respective first plates 23. Furthermore, in the inactive configuration, the second plates 29 each move in rigidly joined relation with a respective first plate 23, i.e. each second plate 29 follows the movement of its respective first plate 23 with which it is associated as it moves from the open configuration to the clamped configuration.

As shown in FIG. 4c, in the active configuration each second plate 29 presses a respective edge 3a of a wall 3 on a respective first plate 23 to form a respective heat seal 8 of the container 1.

In operation, the second plates 29 are configured to be alternated between the inactive configuration and the active configuration when the first plates 23 are in the clamped configuration. In particular, the second plates 29 move at least partially in the direction of feed of the tube 10, i.e. is toward/away from their respective first plates 23. This component of the movement allows each second plate 29 to press a respective edge 3a on the first plate 23 to define the heat seal 8.

Furthermore, the second plates 29 are also allowed to partially move in the actuation direction “B”, i.e. transverse to the direction of feed “A”, during alternation between the inactive configuration and the active configuration. Therefore, the second plates 29 do not contact the tube 10 when they are in the inactive configuration, and properly press the edges 3a in the active configuration.

1-14. (canceled)

15. A container, comprising:
an envelope made of flexible material, wherein the envelope comprises a lower end and an upper end opposite to the lower end, wherein the envelope is closed at least at the lower end, and wherein the envelope comprises:
a pair of opposite first walls, each having a respective edge at the lower end of the envelope;
a base at the lower end of the envelope, which is configured to rest upon a support surface; and
a pair of additional walls between the first walls, wherein each additional wall is joined to the first walls via a pair of additional edges, and wherein each additional wall has a respective lower folding zone at the base;
wherein the edges are each defined by a respective heat seal formed between a respective first wall and the base for supporting the envelope,
wherein the base is formed with a shape that defines a concavity designed to face the support surface,
wherein the base comprises a pair of half-parts separated by a central fold to define the concavity,
wherein the container is obtainable by:
providing a continuous tube made of flexible material, wherein the tube comprises the opposite first walls, the additional walls, and the additional edges; and
folding the additional walls toward an interior of the tube to define the lower folding zones, to move the half-parts of the base toward each other, and to define the concavity on the base.

16. The container of claim 15, wherein the heat seals extend along an entire length of the edges.

17. The container of claim 15, wherein the edges are parallel to each other.

18. The container of claim 15, wherein each heat seal has a transverse extent of at least 0.5 millimeters (mm).

19. The container of claim 15, wherein each heat seal has a transverse extent of at least 1 millimeter (mm).

20. The container of claim 15, wherein the container is configured to stably stand with the base facing the support surface when the container is empty.

21. The container of claim 15, wherein the container is configured to stably stand on the heat seals when the container is empty.

22. A method of fabricating a container, the method comprising:
providing a continuous tube made of flexible material, the tube comprising at least one pair of opposite first walls;
forming a base of an envelope, wherein the base is configured to rest upon a support surface, wherein the base comprises a pair of half-parts separated by a central fold to define a concavity on the base, wherein the concavity is configured to face the support surface; and
separating a portion of the tube comprising the base to define the envelope;
wherein the envelope comprises the at least one pair of opposite first walls each defined by a portion of a respective first wall of the tube and the base;
wherein the forming of the base of the envelope comprises:
sealing the tube at a first sealing area; and
defining an edge on each first wall at the first sealing area;
wherein defining the edge on each first wall comprises heat-sealing the tube between the first walls and the base to define a heat seal at each edge,
wherein the tube has a pair of additional walls between the at least one pair of opposite first walls, wherein each additional wall is joined to the at least one pair of opposite first walls via a pair of additional edges, and
wherein the forming of the base of the envelope further comprises:
folding the additional walls toward an interior of the tube to define in each of the additional walls a respective lower folding zone at the base, to move the half-parts of the base toward each other, and to define the concavity on the base.

23. The method of claim 22, wherein the heat-sealing of the tube between the first walls and the base to define the heat seal at each edge is carried out simultaneously on both edges.

24. The method of claim 23, wherein during the forming of the base of the envelope, the folding of the additional walls precedes the defining of the edge on each first wall at the first sealing area.

25. The method of claim 22, wherein the sealing of the tube at the first sealing area comprises applying first and second cross heat seals on the tube.

26. The method of claim 25, wherein the separating of the portion of the tube comprising the base comprises sealing the tube at a second sealing area and cutting the tube between the first and second cross heat seals.

27. An apparatus for fabricating a container, the apparatus comprising:
feeding means configured to feed a continuous tube made of flexible material;
first heat-sealing means at a processing zone, wherein the first heat-sealing means is configured to face walls of the tube to heat-seal the walls of the tube and to define a sealing area on the tube;
cutting means at the processing zone, wherein the cutting means is configured to face the sealing area to cut the tube and to separate an envelope from the tube; and
second heat-sealing means at the processing zone, wherein the second heat-sealing means is configured to face the walls of the tube to heat-seal each wall at an edge of the wall and to define heat seals of the container.

28. The apparatus of claim 27, wherein the first heat-sealing means comprises a pair of first plates that face each other and are each configured to face a respective wall of the tube, and
wherein the second heat-sealing means comprises a pair of second plates, each associated with a respective first plate, to define the heat seals of the container at the edges of the walls.

29. The apparatus of claim 28, wherein the first plates are configured to alternate between an open configuration, in which the first plates are spaced apart from each other by a distance greater than a distance between the walls of the tube to allow the tube to slide between the walls of the tube, and a clamped configuration, in which each of the first plates contacts a respective wall to press the walls together and to heat-seal the walls, and
wherein the second plates are configured to alternate between an inactive configuration, in which the second plates are spaced apart from the walls, and an active configuration, in which each second plate presses a respective edge on the respective first plate to define the heat seals of the container.

30. The apparatus of claim 29, wherein the second plates are configured to alternate between the inactive configuration and the active configuration when the first plates are in the clamped configuration.

31. The apparatus of claim 30, wherein the second plates are configured to move at least partially in a direction of feed of the tube.

32. The apparatus of claim 31, wherein the second plates are configured to move at least partially in a direction of actuation that is perpendicular to the direction of feed of the tube.

33. The apparatus of claim 28, wherein the first plates are configured to move between an open configuration, in which the first plates are spaced apart from each other by a distance greater than a distance between the walls of the tube to allow the tube to slide between the walls of the tube, and a clamped configuration, in which each of the first plates contacts a respective wall to press the walls together and to heat-seal the walls, and
wherein the second plates are configured to move between an inactive configuration, in which the second plates are spaced apart from the walls, and an active configuration, in which each second plate presses a respective edge on the respective first plate to define the heat seals of the container.

34. The apparatus of claim 33, wherein the second plates are configured to move between the inactive configuration and the active configuration when the first plates are in the clamped configuration.
